(19) United States
(12) Patent Application Publication
(10) Pub. No.: US 2003/0193155 A1
(43) Pub. Date: Oct. 16, 2003

(54) Remanufactured suspension assembly

(76) Inventor: Carl Smith, Lansdale, PA (US)

Correspondence Address: CARL SMITH, 815 McINTOSH WAY, LANDSDALE, PA, 19446, US

(21) Appl. No.: 10/118,699

(22) Filed: Apr. 10, 2002

(51) Int. Cl. B60G 1/00

(52) U.S. Cl. 280/124.1

(57) ABSTRACT

A remanufactured vehicle wheel suspension assembly for use with a vehicle involved in a front-end collision. Assembly includes a coil spring is which compressed onto a strut/shock absorber by insertion of an upper insulator into the top on the coil spring. The coil spring, strut/shock absorber and upper insulator will be from the group consisting of remanufactured, original manufacturer or salvage parts. The ease of installation and use of discarded salvage parts are cost effective and labor efficient for collision repair diagnosis.

### BACKGROUND

1. Field of Invention

This invention relates to a remanufactured vehicle wheel suspension assembly, and more particularly, to an assembly spring loaded and bolted into the knuckle with a bearing pressed in it to be used to replace damaged suspension assemblies as the result of collision damage.

### BACKGROUND OF THE INVENTION

2. Prior Art

Vehicle suspension assemblies have been an integral part of automobiles for years. Accordingly, vehicle suspension assemblies are critical to the safety of all automobiles. Failures of individual suspension parts are typically common in automobiles when they reach over 100,000 miles. One can suspect numerous suspension parts, including knuckles, tie rod ends and struts to fail when a vehicle reached 100,000 miles driven.

Mechanical failure of suspension parts is only one situation where suspension parts need replacement. Failure is also caused by collision damage to the suspension parts. More suspension parts are replaced in this manner than any other. To illustrate the number of failed components, vehicle manufacturers in North America produce over 18,000,000 suspension parts annually and the number of aftermarket parts, those not made by the vehicle manufacturer, are also substantial.

When an automobile is involved in a front-end collision with suspension damage, trial and error is used to determine if parts in the suspension are bent. Due to this archaic method, much time and effort is lost. For example, when an automobile damage appraiser diagnoses the damage incurred by the vehicle, by law (in most states), he can only assess damage that is visible. In doing so, numerous items contained in the suspension assembly may be affected, but are not visible. After the damage to the suspension is examined, the visibly damaged parts are replaced and the vehicle is put on an alignment rack in order to align the suspension. In many instances, the alignment cannot be performed properly as suspension parts are bent but could not visibly be identified as damaged. Most insurance companies require a re-inspection of the vehicle prior to the additional repair, causing delays and additional costs associated with down time such as car rentals and repair inefficiencies in production. Typically, when newly discovered damaged parts are identified, all previous repair procedures must be performed again. Obviously, this is expensive and labor intensive.

In the automotive industry, when vehicles are damaged beyond repair, they ultimately end up in junkyards for dismantling of any salvageable parts. Suspension assemblies are often taken off the vehicles and all that will remain of the assembly is a core. The core is often discarded as it has minimal value to the salvage yard. These cores, however, can be useful in the remanufacture of the assembly using used, remanufactured of original equipment subparts.

This new invention will overcome the trail and error method and give consumers, insurers and repair facilities a cost effective, reliable and safe product that will eliminate the guess work in the repair of suspension assemblies. It will also be much safer to install suspension assemblies, as the technicians will no longer have to press the bearing into the knuckle and compress the support spring onto the strut with a hydraulic jack. The suspension will simply be removed and replaced.

2. Prior Art

Numerous vehicle suspensions have been patented. A typical illustration of such assemblies can be seen in U.S. Patent issued to Doell U.S. Pat. No. 6,152,825 teaches a pre-assembled unit for automotive vehicles, more specifically, a technique to be used during the manufacturing process and fails to examine the use of a remanufactured assembly. Other patents, such as U.S. Pat. No. 6,170,919 to Hoffman teach of suspension assemblies designed make the automobile more fuel-efficient. This suspension assembly is not a complete replacement assembly. Many improvements and modifications to vehicle suspension assemblies have been discovered but have not addressed the need for replacement when damaged.

It is the intent of this new patent to overcome diagnosis inefficiencies in vehicle suspension assemblies and provide a useful means to remanufacture discarded suspension assemblies. It is a further intent of this invention to provide a simplified method of replacement of damaged vehicle suspension and to assure vehicle safety and integrity after a collision accident.

REFERENCE NUMEBERS IN DRAWINGS:

| | |
|---|---|
| Coil Spring | 10 |
| Strut/Shock Absorber | 12 |
| Upper Insulator | 14 |
| Spring Upper Seat | 16 |
| Bearing | 18 |
| Seat | 20 |
| Suspension Support | 22 |
| Lower Insulator | 24 |
| Suspension Nut | 26 |
| Strut Assembly | 28 |
| Splash Shield | 30 |
| Knuckle | 32 |
| Control Arm | 34 |
| Ball Joint | 36 |
| Lower Control Ann | 38 |
| Spring Bumper | 40 |
| Strut Fork | 100 |
| Radius rod | 120 |
| Tensioning strut | 200 |
| Upper control bracket | 210 |

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

FIG. 1—Exploded view of vehicle suspension assembly for a 2000 Toyota Camry.

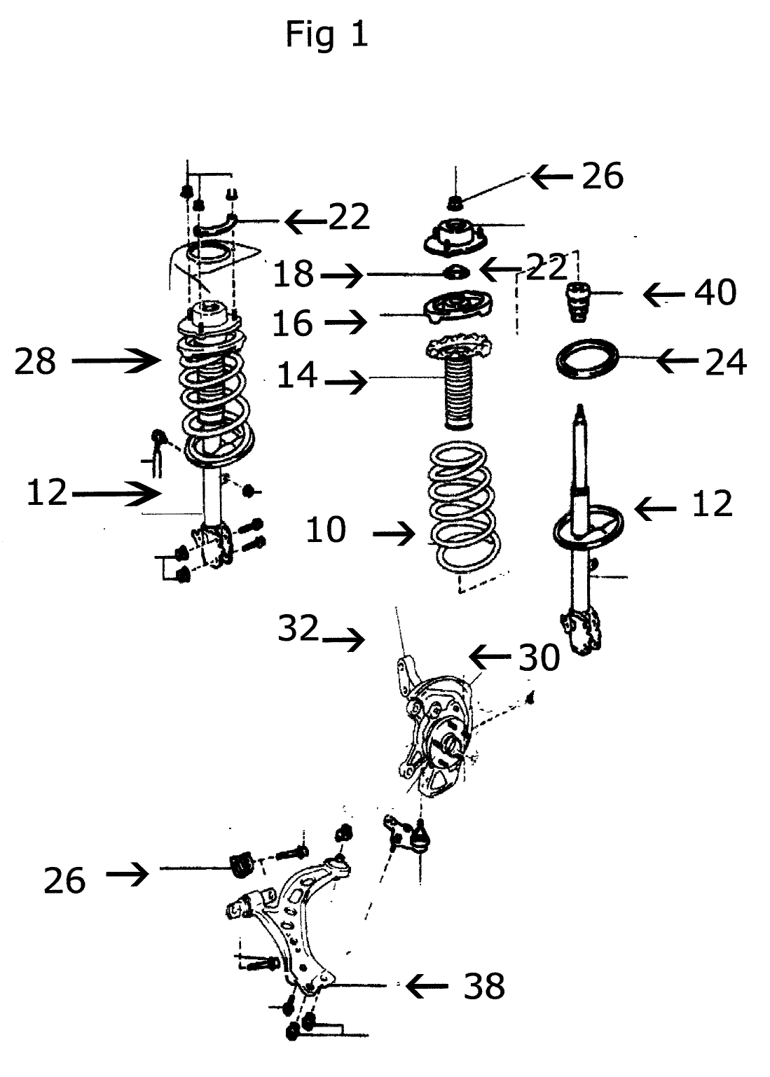

FIG. 2—Partial Assembly of structural components

FIG. 3—Final Assembly of uniknee

FIG. 4—Typical Honda Motor Corporation Assembly

FIG. 5—Typical Chrysler Corporation Assembly

### DETAILED DESCRIPTION OF THE INVENTION

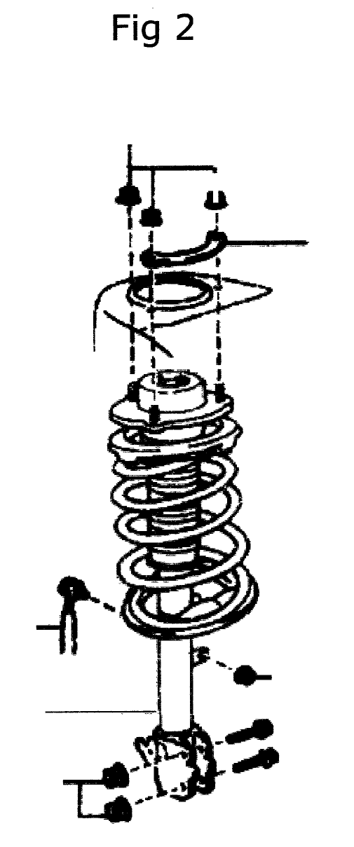

The preferred embodiment of this new invention can be viewed in FIG. 2. For the purposes of this patent, the suspension assembly of a 2000 Toyota Camry LE Sedan is shown. One skilled in the art can easily determine the usefulness and simplicity of the new invention and it's application to other makes and models of vehicles.

Vehicle wheel suspension assemblies typically include a pair of knuckles which rotatably and respectively support the front and/or rear wheels of the vehicle, and a pair of tie rods, each of which operatively connect the steering assembly of the vehicle to a respective and unique one of the knuckles. Particularly, the selective rotation of the steering assembly is transferred through the tie rods to the knuckles, thereby selectively and desirably causing the wheels to turn or rotate, and allowing the vehicle to be selectively steered.

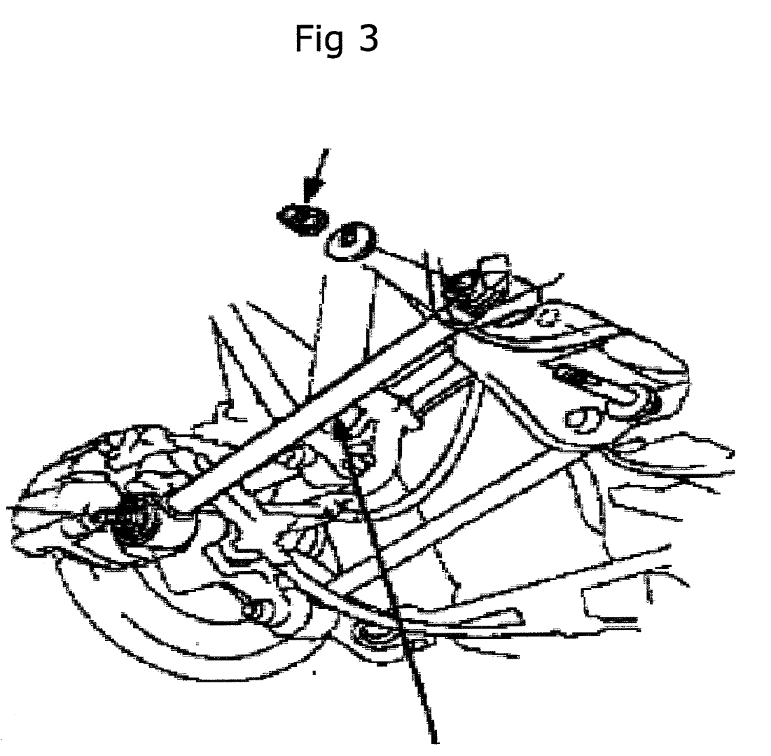

The proposed new invention, herein after referenced as the uniknee, shall be assembled as follows and can be most easily seen as an installed unit in FIG. 3. A coil spring 10 is compressed onto the strut/shock absorber 12 by inserting the upper insulator 14 into the top of the coil spring 10. The coil spring 10, strut/shock absorber 12 and upper insulator 14 can be of any material from the group consisting of remanufactured, original manufacturer or salvage parts. Generally, the uniknee will be manufactured with salvage and remanufactured parts but can also be made in another embodiment with original manufacturer equipment. In the preferred embodiment, the spring upper seat 16 covers the upper insulator 14. The bearing 18 is placed in the middle of the seat 20 and the suspension support 22 is put on top of the bearing 18. The spring upper seat 16, upper insulator 14 and bearing 18 can consist of any material from the group consisting of remanufactured, original manufacturer or salvage parts. The lower insulator 24 is then put on the strut/shock absorber 12 and the spring bumper 40 is put on top of the strut/shock absorber 12 so that it is ready to accept the coil spring 10 and all of its above mentioned components by attaching the suspension nut 26 to the top of the strut/shock 12 becoming a strut assembly 28. The splash shield 30 is screwed onto the knuckle 32 and then the hub and bearing 14 are pressed into the knuckle 32. The strut assembly 28 is bolted onto the knuckle 32 making it a complete uniknee assembly with the control arm 34. The ball joint 36 is bolted to the lower control arm 38 and is ready to be bolted to the vehicle and to the suspension of the vehicle. The uniknee 42 is ready to be installed up into the tower and attached on the topside of the tower using the suspension support 22

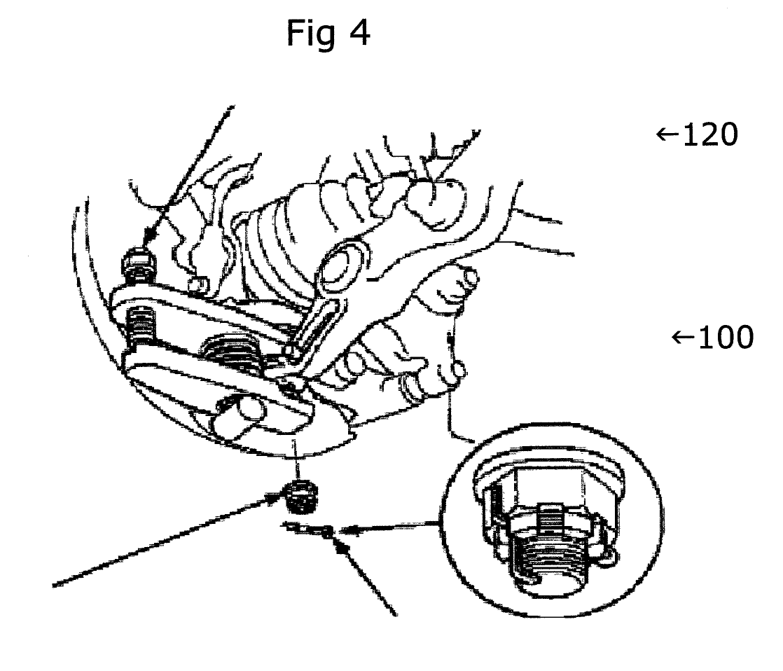

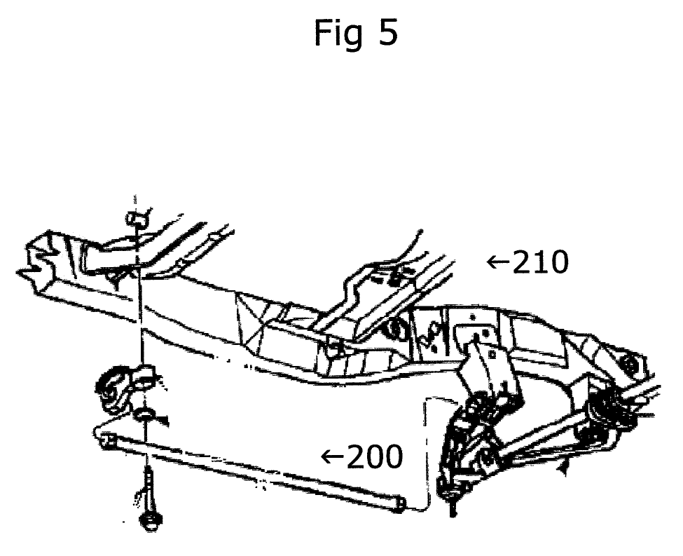

Alternatively, manufacturers have designed a various number of vehicle suspension assemblies that are targeted towards specific objectives as increased handling, lower fuel economy and lower manufacturing costs. In an alternative embodiment as shown in FIG. 4, Honda Motor Corporation makes use of a strut fork 100 and radius rod 120. In another embodiment, Chrysler Corporation makes use of a tensioning strut 200 and upper control bracket 210 as shown in FIG. 5. Those skilled in the art will appreciate that all vehicle suspension assemblies are applicable for remanufacturing. The construction of the Uniknee is unique to each application being serviced.

What is claimed is:

1. A remanufactured vehicle suspension system comprising of at least the following parts:
coil spring, strut/shock absorber, upper insulator, spring upper seat, suspension support, lower insulator, suspension nut, strut assembly, splash shield, knuckle, control arm, ball joint, lower control arm, spring bumper, strut fork, radius rod, tensioning strut and upper control arm bracket where
b) the parts may be selected from the group consisting of remanufactured, original manufacturer or salvage parts.

2. The member of claim 1 wherein the remanufactured vehicle suspension system is installed in a vehicle involved in a front-end collision.
